(19) United States
(12) Patent Application Publication
(10) Pub. No.: US 2013/0103542 A1
(43) Pub. Date: Apr. 25, 2013

(54) PROVIDING PERSONALIZED RESULTS FOR GIFT GIVING UTILIZING A DATABASE

(71) Applicants: Tamer E. ABUELSAAD, Poughkeepsie, NY (US); Jason L. ANDERSON, San Jose, CA (US); Gregory J. BOSS, Saginaw, MI (US); Rick A. HAMILTON, II, Charlottesville, VA (US)

(72) Inventors: Tamer E. ABUELSAAD, Poughkeepsie, NY (US); Jason L. ANDERSON, San Jose, CA (US); Gregory J. BOSS, Saginaw, MI (US); Rick A. HAMILTON, II, Charlottesville, VA (US)

(73) Assignee: INTERNATIONAL BUSINESS MACHINES CORPORATION, Armonk, NY (US)

(21) Appl. No.: 13/276,929

(22) Filed: Oct. 19, 2011

(51) Int. Cl. G06Q 30/06

(52) U.S. Cl. 705/26.41; 705/26.8

(57) ABSTRACT

An approach for providing personalized results for gift giving utilizing a database is provided. The approach includes reviewing, by a processor, an item list of a recipient, determining an item to provide to the recipient that is not on the item list, and sending the item to the recipient. The item list is stored in one or more databases of at least one of a recipient device, a merchant server, and a third party server, for querying of the item list.

### TECHNICAL FIELD

The present invention generally relates to gift giving, and more particularly, to an approach for providing personalized results for gift giving utilizing a database.

### BACKGROUND

With the wide availability of digital marketplaces, ample opportunities exist for consumers to purchase and give gifts. For example, consumers can search for gifts at merchant web sites, purchase the gifts with their credit cards, and have the gifts delivered to their homes or to recipients. In another example, consumers may purchase gifts cards for recipients to redeem at stores and/or merchant web sites. These gift cards may be customized by the consumers to include visual design elements of their choosing.

When a gift recipient receives an item which he or she already owns, the gift recipient can return the item with a gift receipt and/or through the mail. However, this may be both inconvenient and burdensome to the gift recipient. In addition, while gift givers may give cash and/or gift cards for use at stores and/or merchant web sites, some of the gift givers may feel that these options are impersonal.

### SUMMARY

In a first aspect of the invention, a method includes reviewing, by a processor, an item list of a recipient, and determining an item to provide to the recipient that is not on the item list. The method further includes sending the item to the recipient.

In another aspect of the invention, a system implemented in hardware, includes a computer infrastructure operable to determine a list of one or more potential gifts which a giver wants to give to a recipient, at least one of the one or more potential gifts on the list being prioritized by the giver. The computer infrastructure is further operable to send the list of the one or more potential gifts to the recipient such that the recipient redeems at least one gift which the recipient does not have from the list of the one or more potential gifts.

In an additional aspect of the invention, a computer program product includes a computer usable storage medium having readable program code embodied in the medium. The computer program product includes at least one component operable to review an item list of a recipient, determine an item to provide to the recipient that is not on the item list, and send the item to the recipient.

In another aspect of the invention, a method for providing personalized results for gift giving, includes providing a computer infrastructure operable to receive a list of one or more potential gifts which a giver wants to give to a recipient. The computer infrastructure is further operable to determine that the recipient does not have at least one gift on the list of the one or more potential gifts based on a library of one or more items the recipient owns, and grant the at least one gift to the recipient.

In a further aspect of the invention, a computer system for providing personalized results for gift giving, includes a CPU, a computer readable memory and a computer readable storage media. First program instructions determine whether a recipient selected by a giver does not have at least one gift selected by the giver based on a library of one or more items the recipient owns when the library of the one or more items is available. Second program instructions send the at least one gift to the recipient when the recipient does not have the at least one gift, and third program instructions determine a list of one or more potential gifts which the giver wants to give to the recipient when the library of the one or more items is unavailable. Fourth program instructions send the determined list of the one or more potential gifts to the recipient such that the recipient redeems one or more gifts which the recipient does not have from the list of the one or more potential gifts. The first, second, third, and fourth program instructions are stored on the computer readable storage media for execution by the CPU via the computer readable memory.

### BRIEF DESCRIPTION OF THE SEVERAL VIEWS OF THE DRAWINGS

The present invention is described in the detailed description which follows, in reference to the noted plurality of drawings by way of non-limiting examples of embodiments of the present invention.

FIG. 1 shows an illustrative environment for implementing the steps in accordance with aspects of the invention; and

FIGS. 2-4 show flows in accordance with aspects of the invention.

### DETAILED DESCRIPTION

The present invention generally relates to gift giving, and more particularly, to an approach for providing personalized results for gift giving utilizing a database. More specifically, aspects of the present invention provide a gift tool which allows for electronic querying of item libraries of gift recipients so that uniqueness and originality (e.g., personalized results) of gifts for the recipients may be ascertained. The gift tool further allows gift givers to prioritize a list of potential gifts for recipients, and provides the recipients redemption of the gifts, such that the recipients may be satisfied with their gifts.

In embodiments, the gift tool can receive a gift recipient's library or personal inventory of one or more items a recipient already owns or has purchased, from the recipient. The gift tool may use the recipient's library so that a gift giver may avoid giving redundant gifts to the recipient. To accomplish this, the gift tool may receive from the giver the chosen recipient and at least one potential gift which the giver selects to give the recipient. The gift tool may query the recipient's library and determine whether the recipient has the potential gift (or has purchased the potential gift). If the recipient does not have the potential gift, the gift tool may send the gift or a gift voucher for the gift to the recipient, or instruct a merchant to send the gift or the gift voucher to the recipient.

Where the gift tool does not receive or know of the recipient's library, the gift tool can allow the giver to generate a giver list of one or more potential gifts which the giver wants to give to the recipient, and to prioritize the potential gifts. The gift tool may send the giver list to the recipient for the recipient to redeem a gift off the giver list. To do so, a client installed on a computing device of the recipient, and/or a web application accessed by the computing device, may compare the prioritized potential gifts on the giver list to a recipient's library privately stored on the recipient device. The client and/or the web application may grant the recipient a highest priority gift on the giver list that the recipient does not own or has not purchased. In embodiments, once the highest priority gift is granted, the remaining potential gifts on the giver list may not be granted or shown to the recipient, and may be saved for future use by the giver.

Advantageously, aspects of the present invention allow the giver to avoid giving the recipient redundant gifts that the recipient already owns or purchased, in cases where the recipient is willing or not willing to share his or her library or personal inventory of items. Further, aspects of the present invention allow the giver to select potential gifts for the recipient (e.g., achieve personalized results) without revealing all of the potential gifts such that the final, granted gift appears to be more special. In addition, keeping hidden the remaining potential gifts which were not given allows the giver to save and use the ideas for other gift occasions.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM),an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

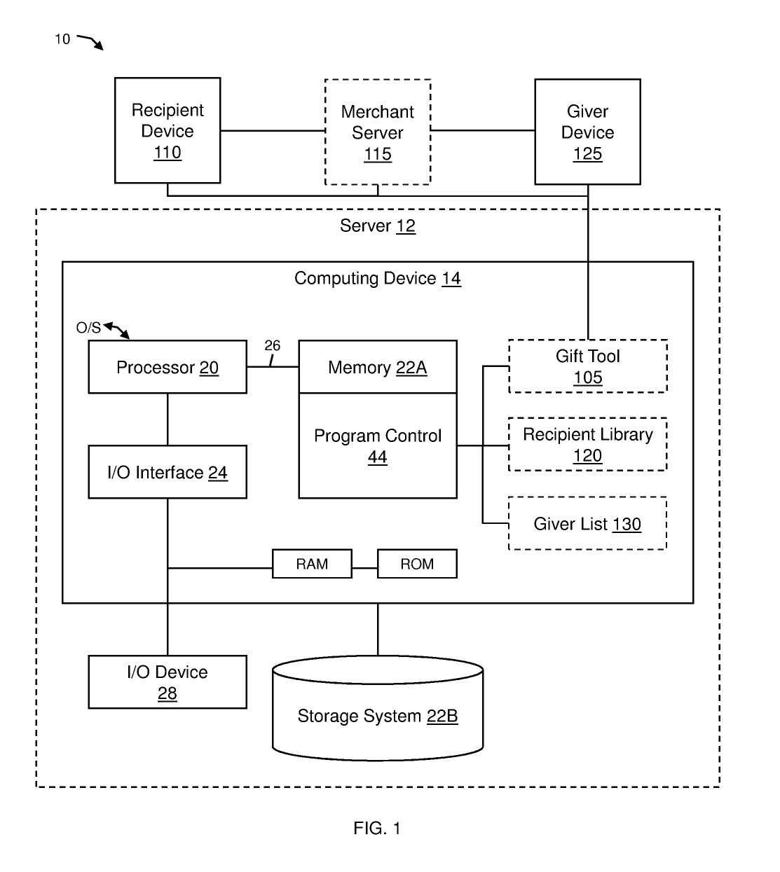

FIG. 1 shows an illustrative environment 10 for managing the processes in accordance with the invention. To this extent, the environment 10 includes a server or other computing system 12 that can perform the processes described herein. In embodiments, the server 12 may include any mobile computing device, such as a mobile phone, a laptop, a video camera, etc. In particular, the server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handset, keyboard, etc.

In general, the processor 20 executes computer program code (e.g., program control 44), which can be stored in the memory 22A and/or storage system 22B. Moreover, in accordance with aspects of the invention, the program control 44 controls a gift tool 105, e.g., the processes described herein. The gift tool 105 can be implemented as one or more program code in the program control 44 stored in memory 22A as separate or combined modules. Additionally, the gift tool 105 may be implemented as separate dedicated processors or a single or several processors to provide the function of this tool. Moreover, it should be understood by those of ordinary skill in the art that the gift tool 105 is used as a general descriptive term for providing the features and/or functions of aspects of the present invention.

In embodiments, the gift tool 105 provides an intelligent way for a gift giver to purchase a gift, a gift card, and/or other related credits for a gift recipient, such that the recipient does not receive an item he or she already owns or has purchased (e.g., the recipient achieves personalized results). More specifically, the gift tool 105 can search for this non-redundant gift where a recipient's personal inventory (e.g., library of one or more items the recipient already owns or has purchased) is known or may be queried. When the recipient's personal inventory is not known, the gift tool 105 may also allow the giver to generate and send to the recipient a gift voucher containing a prioritized list of one or more potential gifts which the recipient may redeem for a gift.

In accordance with further aspects of the present invention, the gift tool 105 can be implemented in the server 12 (e.g., as a third party service), in a recipient device 110, in a merchant server 115, and/or in a giver device 125. Each the recipient device 110 and the giver device 125 may include any type of computing device, such as, e.g., a mobile phone, a smartphone, a personal computer (PC), a laptop, the computing device 14, etc. In embodiments, the recipient device 110 and the giver device 125 may be implemented on a same computing device, or the recipient device 110 may be used to perform functions of the giver device 125, and vice versa. The merchant server 115 may include the server 12 and its associated components, and/or include components similar to those implemented on the server 12, for example, a processor, a memory, etc. The merchant server 115 may provide a merchant web site including an electronic catalog for consumers to search for and purchase items and/or gifts, via consumer devices, e.g, the recipient device 110. The merchant web site may include any type of merchant web site, such as, e.g., an online audio, video, and/or game store or service. The gift tool 105, the recipient device 110, the merchant server 115, and the giver device 125 may be in communication with each other through various types of communication networks and protocols, such as, e.g., e-mail, Short Message Service (SMS), Hypertext Transfer Protocol (HTTP), Session Initiation Protocol (SIP), etc.

In embodiments, the gift tool 105 can receive a recipient library 120, e.g., a recipient's personal inventory of one or more items a recipient already owns or has purchased. The recipient library 120 may be generated by the recipient using, for example, the recipient device 110 to key in (e.g., manually enter) the items into the recipient device 110. The recipient library 120 may also be generated by the recipient accessing the merchant web site provided by the merchant server 115 and selecting (e.g., manually enter) the items the recipient owns from the merchant web site. The recipient library 120 may further be generated by, for example, a third party server which detects the items the recipient owns in a location (e.g., the recipient's home) by, e.g., using sensors to read radio-frequency identification (RFID) tag of the items, and which adds the detected items to the recipient library 120. The recipient library 120 may further include one or more gifts the recipient already received, and/or one or more items ordered from the merchant web site by the recipient or others and/or shipped to the recipient. Accordingly, the recipient library 120 may be received from the recipient device 110 and/or the merchant server 115. The gift tool 105 may store the recipient library 120 in, e.g., the memory 22A, the storage system 22B, and/or databases of the recipient device 110 and/or the merchant server 115. The recipient library 120 may be periodically or persistently maintained with (e.g., uploaded to) the merchant server 115, so that no remote queries of the recipient library 120 need to be made.

In accordance with further aspects of the present invention, the gift tool 105 can use the recipient library 120 to allow the giver to give non-redundant gifts to the recipient, where the recipient library 120 is available or public for the gift tool 105 to query. More specifically, the gift tool 105 may receive from the giver the chosen recipient and at least one potential gift which the giver selects to give the recipient. In embodiments, a preliminary selection of the potential gift may be accomplished before the recipient is chosen. The giver may choose the recipient and the potential gift via the giver device 125 which allows access to the merchant web site provided by the merchant server 115. At the merchant web site or via a client installed on the giver device 125, the giver may select the recipient and the potential gift through, e.g., a pick list, an entry of a canonical name or user identifier (ID), and/or other graphical, textual, or input means, such as gestures via a device touchscreen. Names, user IDs, or other such identifiers associated with selectable gift recipients and items at the merchant web site may be stored in a back-end database of the merchant server 115.

Upon receipt of the recipient and the potential gift from the giver device 125, the gift tool 105 can directly query the stored recipient library 120 in real-time to determine whether the recipient has the potential gift (or has ordered the potential gift). This determining may include comparing the potential gift to each of the items in the recipient library 120 and determining whether the potential gift matches any of the items. If the recipient does not have the potential gift, the gift tool 105 may send the gift or a gift voucher for the gift to the recipient, or instruct the merchant server 115 to send the gift or the gift voucher to the recipient. In embodiments, the gift tool 105 and/or the merchant server 115 may notify the giver device 125 as to which gift was sent or given to the recipient, such that the giver may speak knowledgeably with the recipient about the sent gift. If the recipient does have the potential gift, the gift tool 105 may indicate (e.g., via a message) to the giver device 125 and/or the merchant server 115 that the recipient already has the potential gift and that the giver may have to select another potential gift.

In embodiments, the gift tool 105 can use the recipient library 120 (if known or public) to aid the giver in choosing the potential gift for the recipient. For example, the gift tool 105 may send the recipient library 120 to the giver device 125 (e.g., directly or through the merchant server 115), and the giver device 125 may display the recipient library 120 to the giver. In this way, the giver is able to see the items the recipient already has and to choose a gift that the recipient does not already have. In another example, the gift tool 105 may send the recipient library 120 to the merchant server 115, which based on the recipient library 120, filters the items available at the merchant web site (e.g., removes the items the recipient already has from the merchant web site) for the giver to browse through and select as potential gifts. By using the recipient library 120 to govern what items are displayed to the giver at the merchant web site, the gift tool 105 further assists the giver to choose a gift that the recipient does not already have.

In accordance with further aspects of the present invention, where the recipient library 120 is publicly unavailable for direct query (e.g., not sent to the gift tool 105 and/or the merchant server 115), the gift tool 105 can allow the giver to generate a giver list 130 of one or more potential gifts which the giver wants to give to the recipient. In embodiments, the giver may generate the giver list 130 by choosing the potential gifts through, e.g., the giver device 125 accessing the merchant web site provided by the merchant server 115. The giver may further prioritize the potential gifts on the giver list 130, using either textual, graphical, or other input interfaces (e.g., gestures of a device touchscreen) of the giver device 125 and/or a client installed on the giver device 125. The giver list 130 may be generated at the giver device 125 and/or the merchant server 115, and sent to the gift tool 105. In turn, the gift tool 105 may send the giver list 130 to the recipient device 110 for the recipient to redeem a gift off the giver list 130. The giver list 130 may be stored in persistent memory (e.g., the memory 22A), written to a database (e.g., of the merchant server 115 and/or the server 12), and/or be made available for gift redemption.

In embodiments, the giver may select a last resort gift alternative to include in the giver list 130 in case the recipient has or chooses to decline all of the potential gifts on the giver list 130. The last resort gift alternative may include, but is not limited to, the following:

1) a heuristically-suggested gift determined based on recipient preferences and a recipient's library of one or more items the recipient does not already own, stored in the server 12, the merchant server 115, and/or the recipient device 110;

2) an item from a recipient wish list stored in the server 12, the merchant server 115, and/or the recipient device 110; and

3) a gift card with a value amount for use at a store and/or the merchant web site.

In accordance with further aspects of the invention, upon receipt of the giver list 130, the recipient device 110 can perform a process to redeem a gift off the giver list 130. More specifically, in embodiments, the recipient device 110 (e.g., via a client installed on the recipient device 110 and/or a web application accessed by the recipient device 110) may compare the prioritized potential gifts on the giver list 130 to a recipient library (e.g., the recipient library 120) stored on the recipient device 110. That is, in this case, while the recipient library may be unavailable (e.g., not sent) to the gift tool 105 and/or the merchant server 115, the recipient library may be generated and stored on the recipient device 110 to redeem a gift off the giver list 130. The comparing of the giver list 130 to the recipient library may include extracting a highest priority item from the giver list 130, and determining whether the recipient has the highest priority item based on the recipient library on the recipient device 110.

If the recipient does not have the highest priority item, the recipient device 110 can grant the highest priority item as a gift to the recipient, or instruct the merchant server 115 to send the gift to the recipient, e.g., redeem the gift at the merchant web site. In embodiments, the granting of the highest priority item to the recipient may include allowing the recipient to decline the highest priority item. If the recipient does have the highest priority gift or declines the highest priority gift, the recipient device 110 may extract a next highest priority item from the giver list 130, and determine whether the recipient has the next highest priority item based on the recipient library for redemption. In embodiments, if there are no more remaining items to extract from the giver list 130, the recipient device 110 may grant the last resort gift alternative (e.g., a gift card with a value amount for use at the merchant web site) on the giver list 130 to the recipient. In embodiments, the recipient device 110, the gift tool 105, and/or the merchant server 115 may notify the giver device 125 as to which gift was granted or sent to the recipient, such that the giver may speak knowledgeably with the recipient about the sent gift. In embodiments, once the gift is granted by the recipient device 110, no further potential gifts may be granted or shown to the recipient. In other words, in embodiments, once the recipient receives the gift, then the remaining potential gifts on the giver list 130 may be kept hidden, and saved for future use.

In embodiments, upon receipt of the giver list 130, the recipient device 110 can, additionally or alternatively, display the giver list 130 so that the recipient may view the potential gifts on the giver list 130. These displayed potential gifts may be ranked in a prioritized order or in a random order. When the recipient sees an appealing gift, the recipient may select the appealing gift and redeem the giver list 130 as a gift voucher to be granted the selected gift. For example, upon selection of the appealing gift, the recipient, via the recipient device 110, may send a request to the merchant server 115 to send the selected gift to the recipient. If the recipient owns or declines all of the displayed potential gifts on the giver list 130, the recipient device 110 may grant the recipient the last resort gift alternative, e.g., by requesting the merchant server 115 to deliver the last resort gift alternative to the recipient.

In accordance with further aspects of the present invention, all of the potential gifts on the giver list 130 can be displayed to the recipient for selection. In other embodiments, the giver list 130 may be filtered based on the recipient library on the recipient device 110 to display to the recipient items on the giver list 130 that are not in the recipient library, e.g., not owned by the recipient. In embodiments, a potential gift off the giver list 130 that is declined by the recipient may be later accepted by the recipient. In other embodiments, once a potential gift off the giver list 130 is declined, the recipient may be able to accept only next potential gifts off the giver list 130.

Advantageously, aspects of the present invention allow the giver to select potential gifts for the recipient without revealing all of the potential gifts such that the final, granted gift appears to be more genuine (e.g., to achieve personalized results). Further, keeping hidden the remaining of the potential gifts which were not given allows the giver to save and use the ideas for other gift occasions without giving away any surprises. The aspects of the present invention allow the giver to save the selected potential gifts (e.g., the giver list 130) for the selected recipient or for other potential recipients.

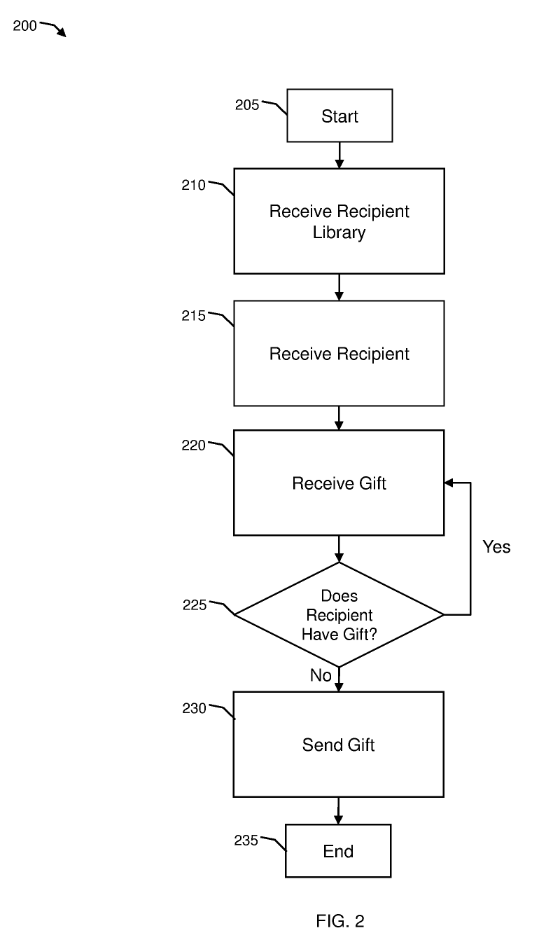

FIGS. 2-4 show flows for performing aspects of the present invention. The steps of FIGS. 2-4 may be implemented in the environment of FIG. 1, for example.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-RJW) and DVD.

FIG. 2 depicts a flow for a process 200 in accordance with aspects of the present invention. The process 200 involves the gift tool 105 in FIG. 1. The process 200 is performed to assist a gift giver to give at least one non-redundant gift to a gift recipient, where a recipient library (e.g., a recipient's personal inventory of one or more items the recipient already owns or has purchased) is available (e.g., sent) to the gift tool. At step 205, the process starts.

At step 210, the gift tool receives the recipient library from a recipient device (e.g., the recipient device 110) and/or a merchant server (e.g., the merchant server 115). At step 215, the gift tool receives an identifier (ID) of the recipient chosen by the giver to receive the gift, from a giver device (e.g., the giver device 125) and/or the merchant server. At step 220, the gift tool receives the gift chosen by the giver to potentially give to the recipient. At step 225, the gift tool directly queries the received recipient library and determines whether the recipient has the potential gift (or has ordered the potential gift). In embodiments, the determining can include comparing the potential gift to each of the items in the recipient library and determining whether the potential gift matches any of the items. If the recipient does not have the potential gift, then the process continues at step 230. Otherwise, the process returns to step 220. At step 230, the gift tool sends the gift or a gift voucher for the gift to the recipient, or instructs the merchant server to send the gift or the gift voucher to the recipient. At step 235, the process ends.

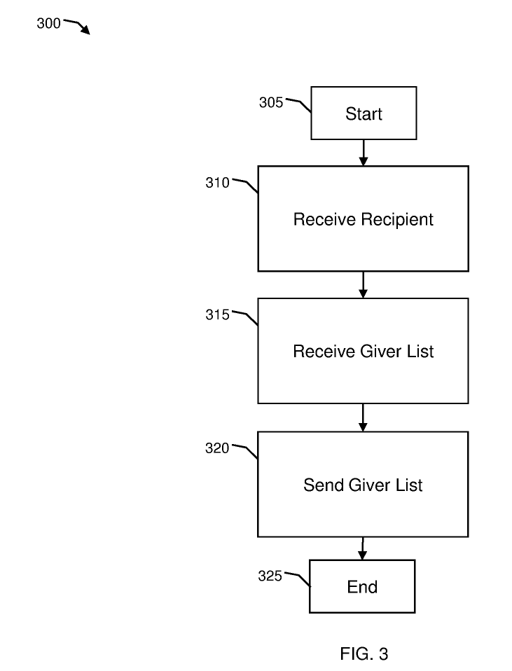

FIG. 3 depicts a flow for a process 300 in accordance with aspects of the present invention. The process 300 involves the gift tool 105 in FIG. 1. The process 300 is performed to assist a gift giver to give at least one non-redundant gift to a gift recipient, where a recipient library (e.g., a recipient's personal inventory of one or more items the recipient already owns or has purchased) is unavailable (e.g., not sent) to the gift tool. At step 305, the process starts.

At step 310, the gift tool receives an identifier (ID) of the recipient chosen by the giver to receive the gift, from a giver device (e.g., the giver device 125) and/or a merchant server (e.g., the merchant server 115). At step 315, the gift tool receives (and possibly stores) a giver list of one or more potential gifts which the giver wants to give to the recipient, from the giver device and/or the merchant server. In embodiments, the giver can generate the giver list by choosing the potential gifts through, e.g., the giver device accessing a merchant web site provided by the merchant server. The giver may further prioritize the potential gifts on the giver list, and may select a last resort gift alternative to be included in the giver list in case the recipient has or chooses to decline all of the potential gifts on the giver list. At step 320, the gift tool sends the giver list to a recipient device (e.g., the recipient device 110) so that the recipient may redeem a gift off of the giver list. At step 325, the process ends.

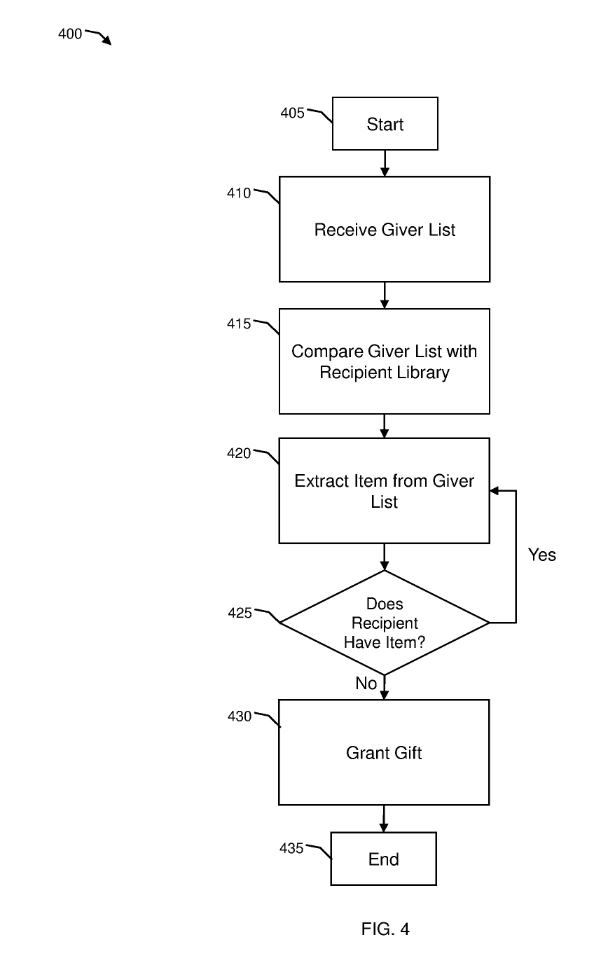

FIG. 4 depicts a flow for a process 400 in accordance with aspects of the present invention. The process 400 involves the recipient device 110 in FIG. 1. The process 400 is performed upon receipt of a giver list (e.g., the giver list 130) of one or more prioritized potential gifts which a gift giver wants to give to a gift recipient, from a gift tool (e.g., the gift tool 105), such that the recipient can redeem a gift off the giver list. At step 405, the process starts.

At step 410, the recipient device receives the giver list from the gift tool. At step 415, the recipient device (e.g., via a client installed on the recipient device) compares the prioritized potential gifts on the giver list to a recipient library (e.g., the recipient library 120) stored on the recipient device. At step 420, the recipient device extracts an item of a highest priority from the giver list. At step 425, the recipient device determines whether the recipient already has the highest priority item based on the recipient library on the recipient device.

If the recipient does not have the highest priority item, the process continues to step 430. Otherwise, the process returns to step 420, where the recipient device extracts another item of a next highest priority from the giver list to determine whether the recipient already has the next highest priority item. At step 430, the recipient device grants the highest priority item as a gift to the recipient, or instructs the merchant server to send the gift to the recipient, e.g., redeems the gift at the merchant web site. In embodiments, if there are no more remaining items to extract from the giver list, the recipient device may grant a last resort gift alternative (e.g., a gift card with a value amount for use at the merchant web site) on the giver list to the recipient. At step 435, the process ends. Accordingly, aspects of the present invention permits smarter purchase decisions to be made where gift givers are providing gifts to gift recipients, offering value to the retail process.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology and provides or utilizes services. In return, the service provider can receive payment from the customer(s) under a subscription and/or fee agreement and/or the service provider can receive payment from the sale of advertising content to one or more third parties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein are intended to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method, comprising:
reviewing, by a processor, an item list of a recipient;
determining an item to provide to the recipient that is not on the item list; and
sending the item to the recipient.

2. The method of claim 1, wherein the item list is generated by at least one of:
a recipient device when the recipient manually enters one or more items;
a merchant server when the recipient selects the one or more items from a web site provided by the merchant server for the item list; and
a third party server which detects the one or more items in a location.

3. The method of claim 1, wherein the item list comprises at least one of:
one or more items the recipient owns;
one or more gifts the recipient received; and
at least one item ordered, purchased, or shipped for the recipient.

4. The method of claim 1, wherein the item list is stored in one or more databases of at least one of a recipient device, a merchant server, and a third party server, for querying of the item list.

5. The method of claim 1, wherein the determining of the item further comprises:
comparing the item to each of one or more items in the item list; and
determining that the item does not match each of the one or more items in the item list.

6. The method of claim 1, wherein the sending of the item further comprises instructing a merchant server to send the item to the recipient.

7. The method of claim 1, further comprising notifying a giver who selected the item as to whether the item is sent to the recipient.

8. The method of claim 1, further comprising sending the item list to a giver such that the giver is able to see and select the item based on the item list.

9. The method of claim 1, further comprising sending the item list to a merchant server which filters one or more available items at a merchant web site provided by the merchant server based on the item list.

10. The method of claim 1, wherein a service provider at least one of creates, maintains, deploys, and supports a computer infrastructure operable to the steps of claim 1.

11. The method of claim 1, wherein the steps of claim 1 are provided by a service provider on a subscription, advertising, and/or fee basis.

12. A system implemented in hardware, comprising:
a computer infrastructure operable to:
determine a list of one or more potential gifts which a giver wants to give to a recipient, at least one of the one or more potential gifts on the list being prioritized by the giver; and
send the list of the one or more potential gifts to the recipient such that the recipient redeems at least one gift which the recipient does not have from the list of the one or more potential gifts.

13. The system of claim 12, wherein the list of the one or more potential gifts is generated by a merchant server when the giver selects the one or more potential gifts from a web site provided by the merchant server for the list of the one or more potential gifts.

14. The system of claim 12, wherein the list of the one or more potential gifts further comprises a last resort gift alternative in case the recipient one of owns and selects to decline all of the one or more potential gifts.

15. The system of claim 14, wherein the last resort gift alternative comprises at least one of:
a gift determined based on one or more preferences of the recipient and a recipient library of one or more items the recipient is without;
an item from a recipient wish list; and
a gift card with a value amount for use at least one of a store and a merchant web site.

16. A computer program product comprising a computer usable storage medium having readable program code embodied in the storage medium, the computer program product includes at least one component operable to:
review an item list of a recipient;
determine an item to provide to the recipient that is not on the item list; and
send the item to the recipient.

17. The computer program product of claim 16, wherein the item list comprises at least one of:
one or more items the recipient owns;
one or more gifts the recipient received; and
at least one item ordered, purchased, or shipped for the recipient.

18. A method of deploying a system for providing personalized results for gift giving, comprising:
providing a computer infrastructure operable to:
receive a list of one or more potential gifts which a giver wants to give to a recipient;
determine that the recipient does not have at least one gift on the list of the one or more potential gifts based on a library of one or more items the recipient owns; and
grant the at least one gift to the recipient.

19. The method of claim 18, wherein the library of the one or more items is stored in a database of a recipient device, for querying of the library of the one or more items.

20. The method of claim 18, wherein at least one of the one or more potential gifts on the list is prioritized by the giver.

21. The method of claim 20, wherein the determining that the recipient does not have the at least one gift further comprises:
extracting a highest priority item from the list of the one or more potential gifts; and
determining that the recipient does not have the highest priority item based on the library of the one or more items, such that the highest priority item is granted as the at least one gift to the recipient.

22. The method of claim 21, wherein the determining that the recipient does not have the at least one gift further comprises:
extracting a next highest priority item from the list of the one or more potential gifts when at least one of the recipient has the highest priority item and the recipient declines the highest priority item; and
determining that the recipient does not have the next highest priority item based on the library of the one or more items, such that the next highest priority item is granted as the at least one gift to the recipient.

23. The method of claim 18, further comprising at least one of:
displaying the list of the one or more potential gifts to the recipient such that the recipient is able to see and select the at least one gift from the list of the one or more potential gifts; and
displaying a filtered list of the one or more potential gifts, the filtered list being filtered based on the library of the one or more items.

24. A computer system for providing personalized results for gift giving, comprising:
a CPU, a computer readable memory and a computer readable storage media;
first program instructions to determine whether a recipient selected by a giver does not have at least one gift selected by the giver based on a library of one or more items the recipient owns when the library of the one or more items is available;
second program instructions to send the at least one gift to the recipient when the recipient does not have the at least one gift;
third program instructions to determine a list of one or more potential gifts which the giver wants to give to the recipient when the library of the one or more items is unavailable; and
fourth program instructions to send the determined list of the one or more potential gifts to the recipient such that the recipient redeems one or more gifts which the recipient does not have from the list of the one or more potential gifts,
wherein the first, second, third, and fourth program instructions are stored on the computer readable storage media for execution by the CPU via the computer readable memory.

25. The computer system of claim 24, wherein:
the determining of whether the recipient does not have the at least one gift further comprises:
comparing the at least one gift to each of the one or more items in the library; and
determining whether the at least one gift does not match each of the one or more items in the library; and
at least one of the one or more potential gifts on the list is prioritized by the giver.
